(19) United States
(12) Patent Application Publication
(10) Pub. No.: US 2024/0365199 A1
(43) Pub. Date: Oct. 31, 2024

(54) SYSTEM AND METHOD FOR CELL HANDOVER FROM NON-TERRESTRIAL NETWORKS TO TERRESTRIAL NETWORKS

(71) Applicant: TURKCELL TEKNOLOJI ARASTIRMA VE GELISTIRME ANONIM SIRKETI, Istanbu (TR)

(72) Inventor: Mehmet Izzet SAGLAM, Istanbul (TR)

(73) Assignee: TURKCELL TEKNOLOJI ARASTIRMA VE GELISTIRME ANONIM, Istanbu (TR)

(21) Appl. No.: 18/684,313

(22) PCT Filed: Aug. 25, 2022
(86) PCT No.: PCT/TR2022/050910

§ 371 Date: Feb. 16, 2024

(30) Foreign Application Priority Data
Aug. 27, 2021 (TR) 2021/013529

(51) Int. Cl. H04W 36/32; H04W 36/08; H04W 36/30

(52) U.S. Cl. CPC H04W 36/322; H04W 36/083; H04W 36/302

(57) ABSTRACT

The present invention relates to a system and method for receiving GNSS (Global Navigation Satellite System) and ephemeris data in a 5G new radio network, and realizing data handover between terrestrial networks and non-terrestrial networks in accordance with the level and quality of signal by processing the received data.

### TECHNICAL FIELD

The present invention relates to a system and method for receiving GNSS (Global Navigation Satellite System) and ephemeris data in a 5G new radio network, and realizing data handover between terrestrial networks and non-terrestrial networks in accordance with the level and quality of signal by processing the received data.

### BACKGROUND OF THE INVENTION

Service areas of mobile operators consist of terrestrial networks and non-terrestrial networks and when it is determined that users are located in terrestrial network boundaries, transition transaction of user devices from terrestrial networks to non-terrestrial networks, which is called as hand-out, is carried out according to 3GPP standardization. Transition can be provided during a hand-out process on the basis of A2 reporting or signal level of the 5G terrestrial network base station wherein the user device is connected; service continuity can be ensured by switching the user device connection from 5G to 4G. However, there are factors making it difficult to successfully complete the transaction whereby transfer is made from base stations which are included in low earth orbit, medium earth orbit and geostationary orbit satellites composing the cells of non-terrestrial networks—that are used in 5G new radio network of user devices—and in autonomous vehicles apart from the orbit, to terrestrial network base stations and the said transaction is called as hand-in according to 3GPP standardization. The level of signal measured at the boundary of cells of non-terrestrial networks is too close to the level of signal measured in the middle of the cell; signal level, quality of the user terminal or re-selection of cell or triggering of intercellular transition is not possible based on time; due to the fact that base stations of non-terrestrial networks are mobile, predictability of exit time of a user device from a cell decreases. These factors complicate the preference of all factors, which are used as transition criteria between cells in terrestrial networks, for transition from non-terrestrial network cells to terrestrial network cells of the user devices in 5G new radio network.

Nevertheless, tracking the coverage area and boundaries of the said non-terrestrial network cells is possible by means of GNSS and ephemeris comprising the movement data of low earth orbit, medium earth orbit and geostationary orbit satellites composing the said cells, and the autonomous vehicles apart from the orbit. Due to the fact that distance of non-terrestrial network cells to earth is known, it is possible to track the movement of satellites and autonomous vehicles and thus the coverage area of base stations according to the GNSS data and ephemeris of satellites and vehicles. No application wherein GNSS data and ephemeris of satellites and autonomous vehicles are used for transferring user devices from non-terrestrial network cells to terrestrial network cells and whereby hand-in transaction is improved has been found.

Considering the deficiencies of a transaction for transition from terrestrial network cells to non-terrestrial network cells in a 5G new radio network included in the current technique, it is seen that there is need in the state of the art for a system and method for receiving GNSS and ephemeris data in a 5G new radio network, and realizing data handover between terrestrial networks and non-terrestrial networks in accordance with the level and quality of signal by processing the received data.

The International patent document no. WO2021092494, an application in the state of the art, discloses a system and method for providing access to non-terrestrial networks in a 5G network. The said system enables to provide mobile network service to user devices over fixed tracking areas and fixed cells in a 5G public land mobile network.

### SUMMARY OF THE INVENTION

The objective of the present invention is to realize a system and method for receiving GNSS and ephemeris data in a 5G new radio network, and realizing data handover between terrestrial networks and non-terrestrial networks in accordance with the level and quality of signal by processing the received data.

### DETAILED DESCRIPTION OF THE INVENTION

“System and Method for Cell Handover from Non-Terrestrial Networks to Terrestrial Networks” realized to fulfil the objective of the present invention is shown in the figures attached, in which:

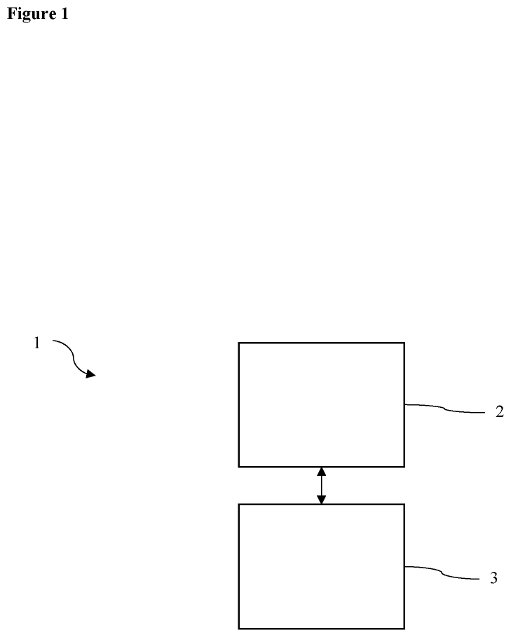

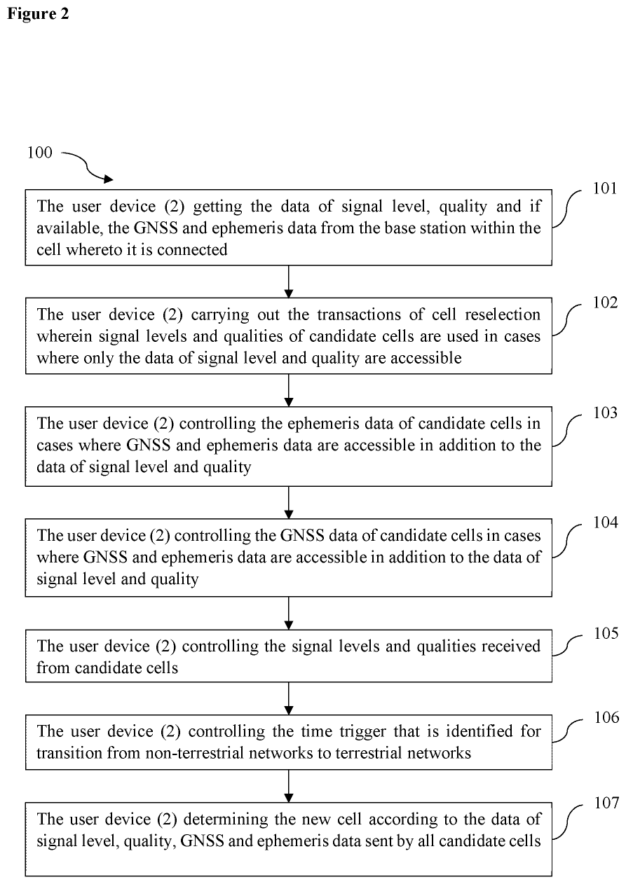

FIG. 1 is a schematic block diagram of the inventive device.

The components illustrated in the figures are individually numbered, where the numbers refer to the following:
1. System
2. User device
3. Non-terrestrial base station
100. Method

The inventive system (1) for receiving GNSS and ephemeris data in a 5G new radio network, and realizing data handover between terrestrial networks and non-terrestrial networks in accordance with the level and quality of signal by processing the received data comprises:
at least one user device (2) which is configured to enable users to get telecommunications service from a 5G network; to receive the data of signal level, quality and if available, the GNSS and ephemeris data of the base station where they are connected; to select a method for cell reselection according to the available data types, by classifying the received data; to connect to a new cell by determining the suitable cell according to the selected method for cell reselection; and
at least one non-terrestrial base station (3) which is configured to provide telecommunications service to the user devices (2); to share the data of signal level, quality and if available, the GNSS and ephemeris data with the user devices (2); to complete the hand-in and hand-out transactions of the user devices (2) that switch from a terrestrial network and are transferred to a terrestrial network.

The user device (2) included in the inventive system (1) is configured to enable users to get telecommunications service from a 5G network; to receive the data of signal level, quality and if available, the GNSS and ephemeris data of the base station where they are connected; to select a method for cell reselection according to the available data types, by classifying the received data; to connect to a new cell by determining the suitable cell according to the selected method for cell reselection. In one preferred embodiment of the invention, the user device (2) is configured to carry out transactions of cell reselection wherein signal levels and quality of candidate cells are used in cases where only the data of signal level and quality are accessible. In one preferred embodiment of the invention, the user device (2) is configured to ensure that GNSS and ephemeris data of candidate cells are controlled; signal levels and qualities are controlled in the event that GNSS and ephemeris data are accessible in addition to the data of signal level and quality; and to control the time trigger that is identified for transition from non-terrestrial networks to terrestrial networks; to determine the new cell according to the data of signal level, quality, GNSS and ephemeris data sent by all candidate cells.

The non-terrestrial base station (3) included in the inventive method (100) is configured to provide telecommunications service to the user devices (2); to share the data of signal level, quality and if available, the GNSS and ephemeris data with the user devices (2); to complete the hand-in and hand-out transactions of the user devices (2) that switch from a terrestrial network and are transferred to a terrestrial network. In one preferred embodiment of the invention, the non-terrestrial base station (3) is configured to transmit the GNSS and ephemeris data of the satellite or autonomous vehicle, whereon it is located, to the user devices (2) sending the data request for the hand-in transaction.

The method (100) for receiving GNSS and ephemeris data in a 5G new radio network, and realizing data handover between terrestrial networks and non-terrestrial networks in accordance with the level and quality of signal by processing the received data comprises the steps of:
the user device (2) getting the data of signal level, quality and if available, the GNSS and ephemeris data from the base station within the cell whereto it is connected (101);
the user device (2) carrying out the transactions of cell reselection wherein signal levels and qualities of candidate cells are used in cases where only the data of signal level and quality are accessible (102);
the user device (2) controlling the ephemeris data of candidate cells in cases where GNSS and ephemeris data are accessible in addition to the data of signal level and quality (103);
the user device (2) controlling the GNSS data of candidate cells in cases where GNSS and ephemeris data are accessible in addition to the data of signal level and quality (104);
the user device (2) controlling the signal levels and qualities received from candidate cells (105);
the user device (2) controlling the time trigger that is identified for transition from non-terrestrial networks to terrestrial networks (106);
the user device (2) determining the new cell according to the data of signal level, quality, GNSS and ephemeris data sent by all candidate cells (107).

### Industrial Application of the Invention

In the inventive method (100), the user device (2) gets the data of signal levels and qualities of the base stations of all candidate cells that it can access in its current location and the GNSS and ephemeris data, if provided by the base stations (3) (101); it carries out the transactions of cell reselection wherein signal levels and qualities of candidate cells are used in cases where only the data of signal level and quality are accessible from candidate cells among the received data (102). The ephemeris data (103) and the GNSS data (104) of candidate cells, which are created by non-terrestrial base stations (3), are controlled at first in cases where GNSS and ephemeris data are available in addition to the data of signal level and quality among the data transmitted to the user device (2); the signal levels and qualities received from candidate cells are controlled (105); the time trigger, which is identified for transition from non-terrestrial networks to terrestrial networks, is controlled (106); and the user device (2) determines the new cell according to the data of signal level, quality, GNSS and ephemeris data sent by all candidate cells (107). Thereby, it is ensured that hand-in transactions can be carried out by determining the user devices (2) that should be included in a base station in a terrestrial network, by leaving the coverage area of the non-terrestrial base stations (3) according to variables of signal level and quality.

Within these basic concepts; it is possible to develop various embodiments of the inventive “System and Method for Cell Handover from Non-Terrestrial Networks to Terrestrial Networks (1)”; the invention cannot be limited to examples disclosed herein and it is essentially according to claims.

1. A system (1) for receiving GNSS and ephemeris data in a 5G new radio network, and realizing data handover between terrestrial networks and non-terrestrial networks in accordance with the level and quality of signal by processing the received data; characterized by
at least one user device (2) which is configured to enable users to get telecommunications service from a 5G network; to receive the data of signal level, quality and if available, the GNSS and ephemeris data of the base station where they are connected; to select a method for cell reselection according to the available data types, by classifying the received data; to connect to a new cell by determining the suitable cell according to the selected method for cell reselection; and
at least one non-terrestrial base station (3) which is configured to provide telecommunications service to the user devices (2); to share the data of signal level, quality and if available, the GNSS and ephemeris data with the user devices (2); to complete the hand-in and hand-out transactions of the user devices (2) that switch from a terrestrial network and are transferred to a terrestrial network.

2. A system (1) according to claim 1; characterized by the user device (2) which is configured to carry out transactions of cell reselection wherein signal levels and qualities of candidate cells are used in cases where only the data of signal level and quality are accessible.

3. A system (1) according to claim 1; characterized by the user device (2) which is configured to ensure that GNSS and ephemeris data of candidate cells are controlled; signal levels and qualities are controlled in the event that GNSS and ephemeris data are accessible in addition to the data of signal level and quality; and to control the time trigger that is identified for transition from non-terrestrial networks to terrestrial networks; to determine the new cell according to the data of signal level, quality, GNSS and ephemeris data sent by all candidate cells.

4. A system (1) according to claim 1; characterized by the non-terrestrial base station (3) which is configured to transmit the GNSS and ephemeris data of the satellite or autonomous vehicle, whereon it is located, to the user devices (2) sending the data request for the hand-in transaction.

5. A method (100) for receiving GNSS and ephemeris data in a 5G new radio network, and realizing data handover between terrestrial networks and non-terrestrial networks in accordance with the level and quality of signal by processing the received data; characterized by the steps of:
the user device (2) getting the data of signal level, quality and if available, the GNSS and ephemeris data from the base station within the cell whereto it is connected (101);
the user device (2) carrying out the transactions of cell reselection wherein signal levels and qualities of candidate cells are used in cases where only the data of signal level and quality are accessible (102);
the user device (2) controlling the ephemeris data of candidate cells in cases where GNSS and ephemeris data are accessible in addition to the data of signal level and quality (103);
the user device (2) controlling the GNSS data of candidate cells in cases where GNSS and ephemeris data are accessible in addition to the data of signal level and quality (104);
the user device (2) controlling the signal levels and qualities received from candidate cells (105);
the user device (2) controlling the time trigger that is identified for transition from non-terrestrial networks to terrestrial networks (106);
the user device (2) determining the new cell according to the data of signal level, quality, GNSS and ephemeris data sent by all candidate cells (107).
